(19) United States
(12) Patent Application Publication
(10) Pub. No.: US 2005/0223343 A1
(43) Pub. Date: Oct. 6, 2005

(54) Cursor controlled shared display area

(76) Inventors: Amy Delphine Travis, Arlington, MA (US); William Michael Quinn, Lexington, KY (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/814,978

(22) Filed: Mar. 31, 2004

(51) Int. Cl. G06F 3/00

(52) U.S. Cl. 715/862; 715/856; 715/759; 715/751

(57) ABSTRACT

Described is a method for sharing a portion of a sharer display with a viewer display. A sharing area that defines the portion of the sharer display to be shown on the viewer display is determined in response to a display allocation of the viewer display and a cursor position in the sharer display. Display data within the sharing area is provided to a viewing computer for presentation on the viewer display. As changes in the position of the cursor in the sharer display are detected, the sharing area is moved to define a different portion of the sharer display and the viewers are presented with new shared display data. The method optionally includes showing a sharing frame on the sharer display to indicate the perimeter of the portion of the sharer display showing on the viewer display.

### FIELD OF THE INVENTION

The invention relates generally to a method for sharing a portion of a sharer display with a viewer. In particular, the invention relates to a method for automatically determining the dimensions of a sharing area and tracking the sharing area to a cursor as the cursor is moved about the sharer display.

### BACKGROUND

Individuals working on related tasks can be located in geographically remote locations. Computing resources can be shared between users, for example, through web conferencing to permit real-time collaboration. A user can demonstrate an application running on a sharer (i.e., host) machine to the other users by sharing the data displayed on the sharer display. Verbal description of the executing application is enabled through telephone communications or online voice transmissions.

Participants in the demonstration who are viewing the shared display data do not necessarily look at the portion of the display that the sharer wants to emphasize. Verbal cues from the sharer can direct the attention of the viewers to specific areas of the display. Whether the viewer has the entire viewer display available for sharing or only a portion as defined by an application window, the available pixel area may not match the shared portion of the sharer display. Thus the sharer does not know what part of the sharer display can be seen by each of the viewers. The sharer can change the resolution of the sharer display. However, the number of pixels available on the viewer displays can differ. Consequently it may be difficult to accommodate the displays for all viewers.

Several methods have been employed to eliminate the viewing problem. The sharer can limit sharing to a particular application running on the sharer computer. However, if the shared application is maximized, the pixel availability problem remains. In another approach, the sharer generates a frame to limit sharing to the portion of the sharer display within the frame. The application to be shared is then moved into the frame or the frame is moved over the items that the sharer wants to show. The pixel availability problem can still occur, depending on the size of the frame. In addition, sharers may not realize that at least some of what they want to share is not in the frame.

What is needed is a method for sharing a portion of a sharer display with a viewer that overcomes the problems described above. The present invention satisfies this need and provides additional advantages.

### SUMMARY OF THE INVENTION

In one aspect, the invention features a method for sharing a portion of a sharer display with a viewer display. A sharing area defining a portion of the sharer display to be shown on the viewer display is determined. The sharing area is responsive to a display allocation for the viewer display and a position of a cursor in the sharer display. The portion of the sharer display is shown on the viewer display. In one embodiment, a new position of the cursor in the sharer display is detected. The sharing area is moved to define a different portion of the sharer display in response to the new position of the cursor and the different portion of the sharer display is shown on the viewer display. In another embodiment, the method includes showing a sharing frame on the sharer display to indicate the perimeter of the portion of the sharer display showing on the viewer display.

In another aspect, the invention features a computer program product for use with a computer system having a sharing computer and a viewing computer. The sharing computer and the viewing computer have a sharer display and a viewer display, respectively. The computer program product includes a computer useable medium having program code for determining a sharing area that defines a portion of the sharer display to be shown on the viewer display. The determination is responsive to a display allocation for the viewer display and a position of a cursor in the sharer display. The computer program product also includes program code for showing the portion of the sharer display on the viewer display.

In another aspect, the invention features a computer data signal embodied in a carrier wave for use with a computer system having a sharing computer and a viewing computer. The sharing computer and the viewing computer have a sharer display and a viewer display, respectively. The computer data signal includes program code for determining a sharing area defining a portion of the sharer display to be shown on the viewer display. The determination is responsive to a display allocation for the viewer display and a position of a cursor in the sharer display. The computer data signal also includes program code for showing the portion of the sharer display on the viewer display.

In another aspect, the invention features a computing system for sharing a portion of a sharer display with a viewer display. The computing system comprises a sharer processor for determining a sharing area defining a portion of the sharer display to be shown on the viewer display in response to display allocation data for the viewer display and position data for a cursor in the sharer display. The computing system also includes a shared data generator for providing shared display data to the viewer display.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of a networked environment having a sharing computer and viewing computers.

FIG. 2 is a block diagram of a conventional personal computer system in which aspects of the invention may be incorporated.

FIGS. 3A, 3B and 3C are graphical representations of the pixel size of a sharer display in comparison with a viewing display.

FIG. 4 is a graphical representation of the location of a sharing area defined on a sharer display.

FIGS. 5A, 5B and 5C are graphical representations of the location of the sharing area of FIG. 4 with respect to different viewing displays.

FIG. 6 is an illustration of a display allocation of a viewer display based on an application window.

FIG. 7 is a flowchart representation of an embodiment of a method for sharing a portion of a sharer display with a viewer display in accordance with the invention.

FIG. 8 is a flowchart representation of the step of determining a sharing area of FIG. 8.

FIGS. 9A, 9B and 9C are graphical representations of a sharing frame in a sharer display according to cursor position in accordance with an embodiment of the invention.

FIG. 10 is a flowchart representation of another embodiment of a method for sharing a portion of a sharer display with a viewer display in accordance with the invention.

### DETAILED DESCRIPTION

In brief overview the present invention relates to sharing a portion of a sharer display with a viewer display. The method of the invention includes determining a sharing area that defines the portion of the sharer display to be shared. The sharing area is determined according to the display allocation of one or more viewer displays and the position of the cursor in the sharer display. As used herein, display allocation refers to the pixels available to display shared content from the sharer display. Optionally, a sharing frame can be displayed on the sharer display to indicate to the sharer what portion of the sharer display is being presented to the viewers.

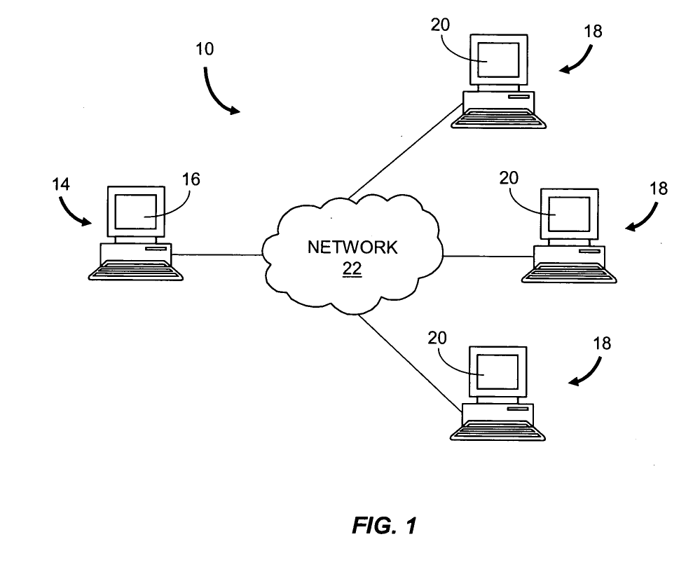

Referring to FIG. 1, a networked environment 10 includes a sharing computer 14 and viewing computers 18 communicating over a network 22. The network 22 can be an intranet, the Internet or any network or combination of networks that supports the transmission of data between the computers 14, 18. The sharing computer 14 includes a sharer display 16 observable by a user (i.e., sharer) sharing content shown on the sharer display 16 with other users (i.e., viewers). Each viewing computer 18 includes a viewer display 20 observable by a viewer. The viewer display 20 is capable of showing at least a portion of the content shown on the sharer display 16.

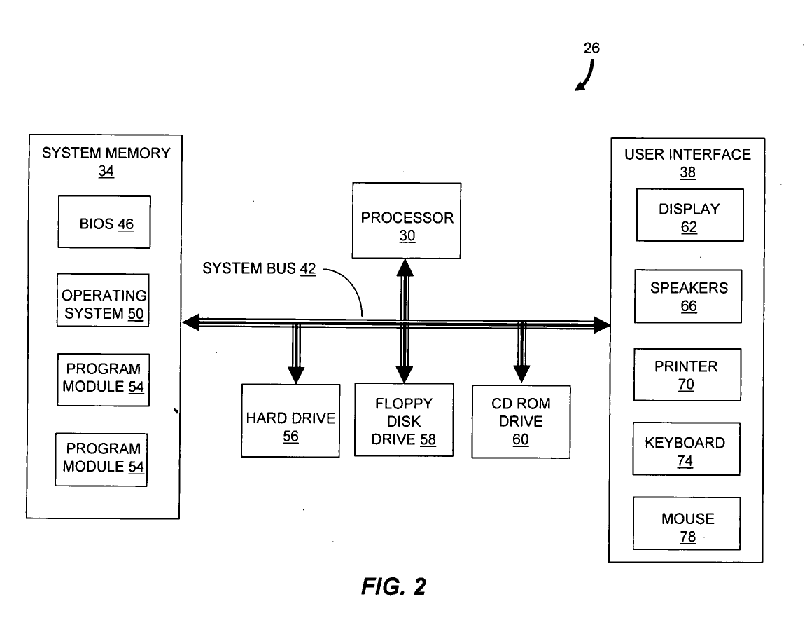

FIG. 2 is a functional block diagram of a conventional personal computer (PC) 26 which can be the sharing computer 14 or one of the viewing computers 18 of FIG. 1. The PC 26 includes a processor 30, a system memory 34 and a user interface 38 coupled to each other over a system bus 42. The system memory 34 includes read-only memory (ROM) and random access memory (RAM). Basic routines used to transfer information between the components of the PC 26 at certain times, such as during startup, are included in a basic input/output system (BIOS) 46 in ROM. The BIOS 46 provides an interface between the PC's operating system 50 (e.g., Windows, Mac OS, Linux) and the specific hardware configuration of the PC 26, including the processor 30 and the system memory 34. The system memory 34 also includes various program modules 54 such as word processing applications, presentation applications and spreadsheet applications.

The PC 26 generally includes other components, for example one or more hard disk drives 56, magnetic disk drives 58, optical disk drives 60 and the like. The drives 56, 58, 60 enable read from and write to operations for various forms of computer-readable media and allow for non-volatile storage of computer readable instructions, data structures and other data. The user interface 38 includes a display 62 (i.e., monitor) and other peripheral output devices, such as speakers 66 and a printer 70, connected through various interface modules (not shown) to the system bus 42. Commands and information are entered into the PC 26 through input devices such as a keyboard 74 and a mouse 78.

A user wishing to share the sharer display 16 with multiple viewers can be adversely affected by the display resolution of the viewer displays 20, especially if the display resolutions vary between viewers. In the following examples it is assumed that the locations of features in the displays are indexed with respect to an origin defined at the upper left comer of each display.

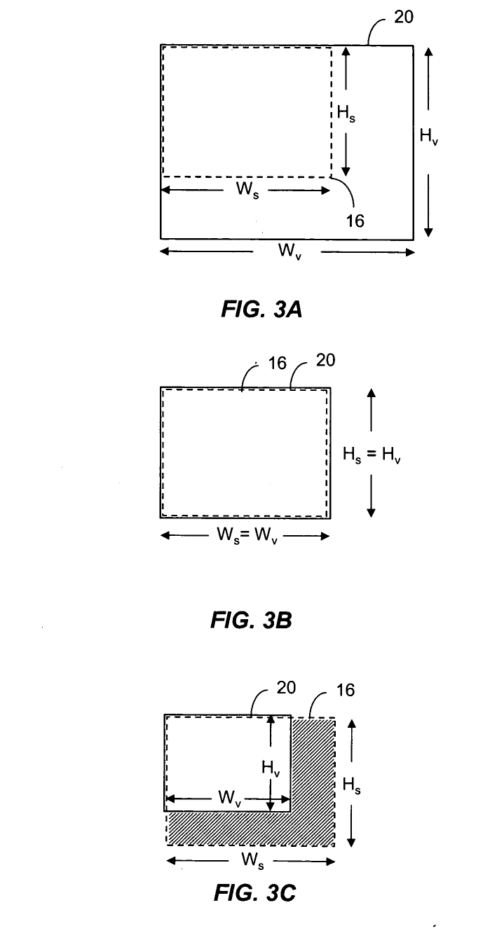

FIG. 3A graphically represents the sharer display 16 superimposed on a viewer display 20 having a greater number of pixels. In particular the width Wₛ and height Hₛ of the sharer display 16 as defined by the number of pixels is less than the width Wᵥ and height Hᵥ of the viewer display 20. Thus a sharer is able to share the entire contents of the sharer display 16 with the viewer but the shared content covers only a portion of the viewer display 20. Potentially, the viewer can decrease the resolution (i.e., decreases the number of pixels shown) of the viewer display 20 to match the resolution of the sharer display 16, thus filling the viewer display 20 with the shared contents.

FIG. 3B illustrates a case in which the dimensions Wₛ, Hₛ and Wᵥ, Hᵥ of the sharer display 16 and the viewer display 20, respectively, are equal. In this instance, the contents shown on the sharer display 16 are fully shared on the viewer display 20 and there are no “unused” pixels.

FIG. 3C represents a case in which the dimensions Wᵥ, Hᵥ of the viewer display 20 are less than the dimensions Wₛ, Hₛ of the sharer display 16. In this instance, a portion of the contents shown on the sharer display 16 cannot be seen by the viewer. In particular, features displayed in the shaded portion of the sharer display 16 cannot be observed.

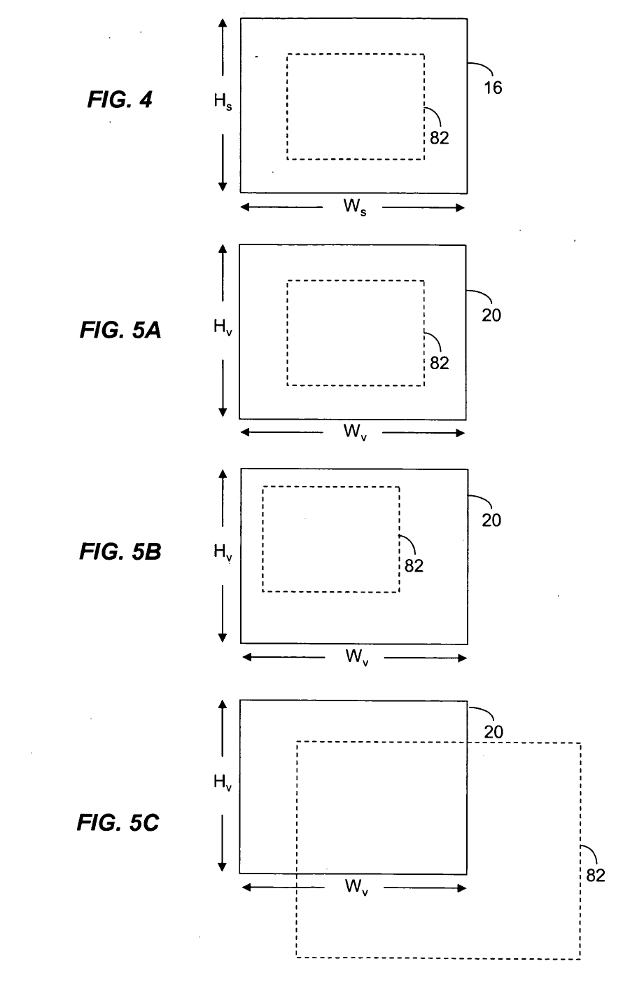

FIG. 4 illustrates a problem that can arise when sharing a portion of a sharer display 16 with viewer displays 20 of varying resolution. A sharing area 82 of the sharer display 16 that a sharer has defined by a rectangular perimeter (dashed lines) for presentation to viewers is shown. In this example, the sharing area 82 is centered in the sharer display 16.

FIG. 5A illustrates a viewer display 20 having the same resolution as the sharer display 16 of FIG. 4. Thus the relative positions of the sharing area 82 on the sharer display 16 and as shown on the viewer display 20 are identical.

FIG. 5B illustrates how the sharing area 82 appears on a viewer display 20 for which the display dimensions Wᵥ, Hᵥ measured in pixels are greater than the dimensions Wₛ, Hₛ of the sharer display 16. Because of the greater resolution, the sharing area 82 is not centered in the viewer display 20 but instead is located closer to the upper left corner. While this does not result in loss of content to the viewer, it can sometimes result in confusion, especially if the sharer is providing verbal cues directed to positions according to the sharer display 16. FIG. 5C shows the sharing area 82 for a viewer display 20 having display dimensions Wᵥ, Hᵥ that are less than the dimensions Wₛ, Hₛ of the sharer display 16. Consequently, the sharing area 82 is positioned lower and farther to the right. Thus there is content in the sharing area 82 that “falls off” the viewer display 20. Moreover, the portion of the sharing area 82 that is lost varies according to the location of the sharing area 82 in the sharer display 16. For example, if the sharing area 82 was established closer to the bottom right corner of the sharer display 16, more of the sharing area 82 would fall off the viewer display 20.

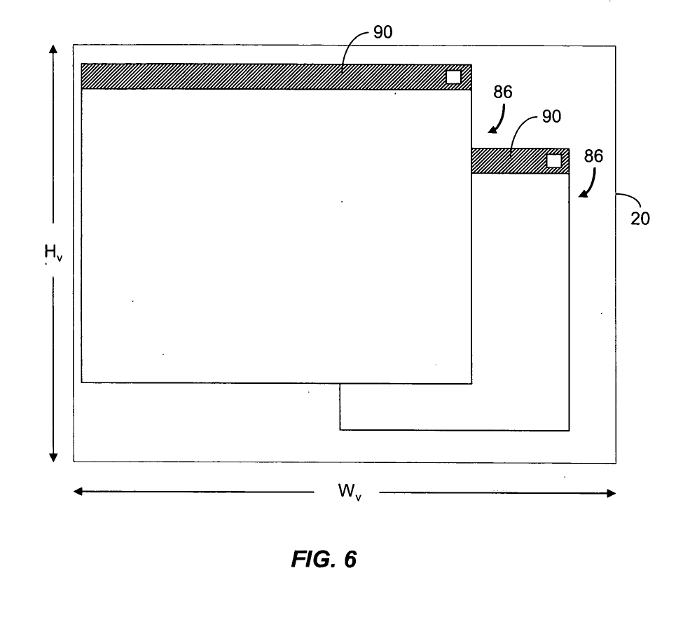

Although the display allocation is limited according to the pixel resolution defined for the viewer display 20, further viewing limitations can exist. For example, a viewer can have multiple windows 86 open in the viewer display 20 as shown in FIG. 6. One of the windows 86 can be utilized for presenting the sharing area 82. Thus the display allocation (i.e., total available pixels) for viewing the sharing area 82 can be substantially less than the number of pixels provided across the full viewer display 20. Moreover, the display allocation can change in time if the viewer elects to resize windows 86 during the sharing session.

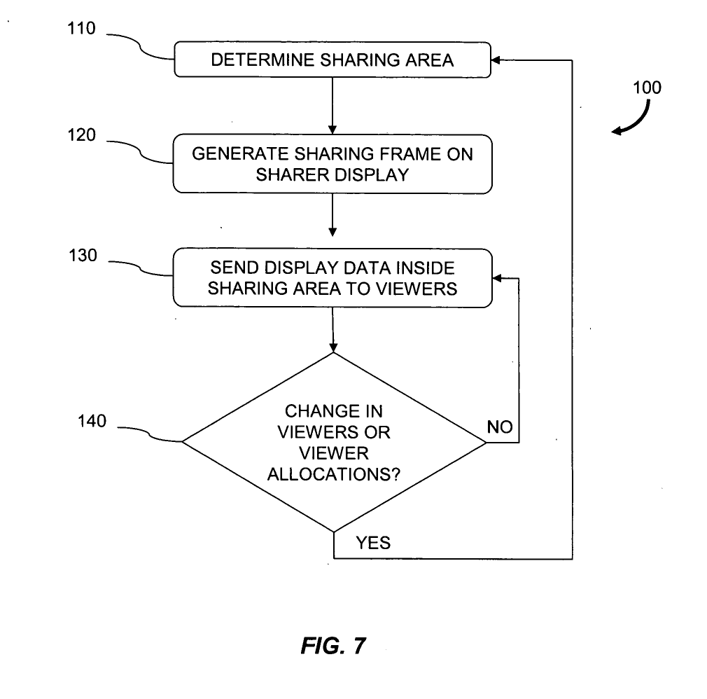

FIG. 7 depicts one embodiment of a method 100 for sharing a portion of a sharer display with a viewer display according to the invention that overcomes the above described problems. The method 100 includes determining (step 110) a sharing area 82, or common area, that defines a portion of the sharer display 16 to be shown on one or more viewer displays 20. The sharing computer 14 determines the sharing area 82 from the current position of the user's cursor in the sharer display 16 and from information provided by the viewing computers 18 indicating their display allocations.

The method 100 also includes generating (step 120) a sharing frame in the sharer display 16 to indicate to the sharer the portion of the sharer display 16 that is being commonly shared. For example, the sharing frame can be the visible manifestation of the dashed lines in FIGS. 4 and 5. The sharing frame is visible only on the sharer display 20 and is generally centered about the sharer cursor as described in more detail below. The color of the sharing frame is selected to contrast with the background color of the sharer display 16. The color of the sharing frame can be set automatically or by allowing the sharer to choose from a pre-set selection of colors. If the sharing frame color matches the color of a feature in the sharer display 20, the frame color is changed to a complementary color where the sharing frame and the feature overlap to ensure visibility of the feature.

Display data in the sharing area 82, including the cursor if it is present, is sent (step 130) to the viewing computers 18. If it is determined (step 140) that a viewing computer 18 has joined the session or left the session, or if a display allocation of a viewer changes, the method 100 returns to step 110 to determine an updated sharing area 82, otherwise the method 100 continues by continuing to send (step 130) display data in the sharing area 82 to the viewing computers 18. Determining changes to the viewers or updated display allocations is accomplished, for example, by periodically polling the viewing computers 18. Alternatively, each viewing computer 18 can automatically forward updated display allocation data to the sharing computer 14 when a change occurs.

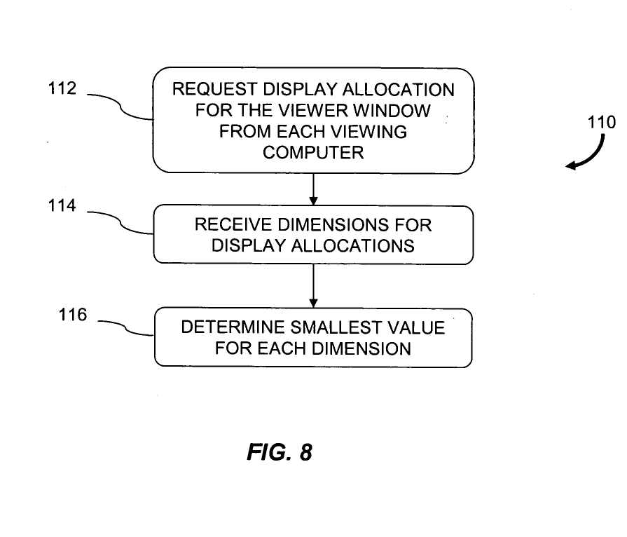

FIG. 8 illustrates an exemplary process for determining (step 110 of FIG. 6) the sharing area 82. The sharing computer 14 sends (step 112) a request to (i.e., polls) the viewing computers 18 for their display allocations. In an alternative embodiment, no request is sent and the viewing computers transmit their display allocations automatically at the beginning of a sharing session or when a change in the dimensions of their display allocations occurs. Display allocations are received (step 114) and compared to each other to determine the smallest value for each display dimension. For example, the display allocations provided by the viewing computers 18 can include rectangular dimensions, i.e., the width Wᵥ and height Hᵥ available for showing the sharing area 82 expressed in pixels. The dimensions of the sharing area 82 are then determined (step 116) to be the smallest width Wᵥ and smallest height Hᵥ. Consequently, all viewer displays 20 have available pixels to show the sharing area 82 without loss of contents.

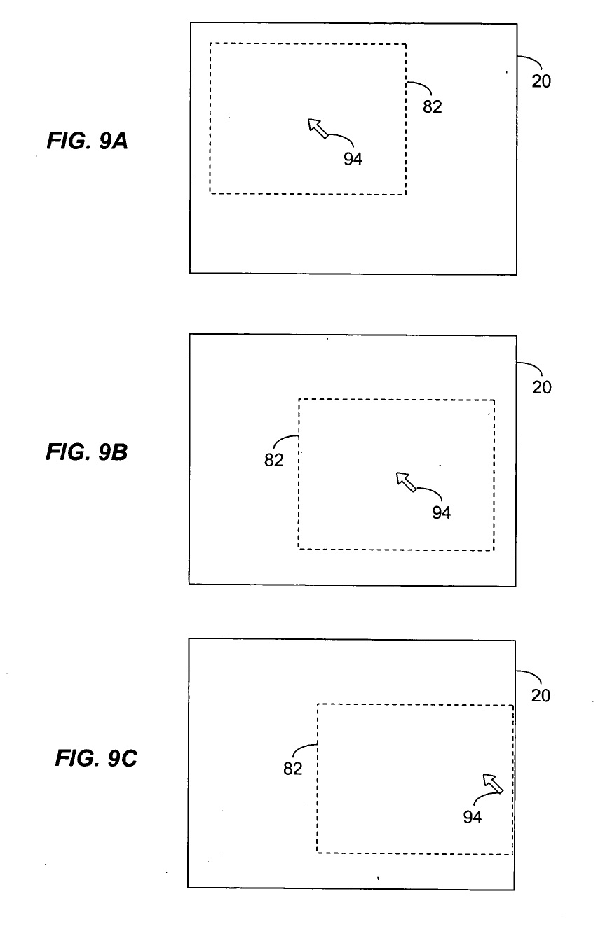

FIG. 9 illustrates the position of the sharing area 82 in the sharer display 20 for three different positions of the sharer cursor 94. In general, the sharing area 82 remains centered about the cursor 94 as shown in FIGS. 9A and 9B. The position of the sharing area 82 changes to follow, or “track”, the position of the cursor 94. In one embodiment, the sharing area 82 tracks the cursor 94 only if the cursor 94 is moved outside the current sharing area 82. If the cursor 94 is moved near the edge of the sharer display 20 as shown in FIG. 9C, the sharing area 82 is prohibited from extending beyond the sharer display 20. Once the distance from the cursor 94 to the right edge of the sharer display 20 is less than half the width of the sharing area 82, movement of the sharing area 82 to the right is halted so that the right edge of the sharing area 82 is coincident with the right edge of the sharer display 20. Similarly, the sharing area 82 is restricted from extending beyond the top, bottom and left edges of the sharer display 20.

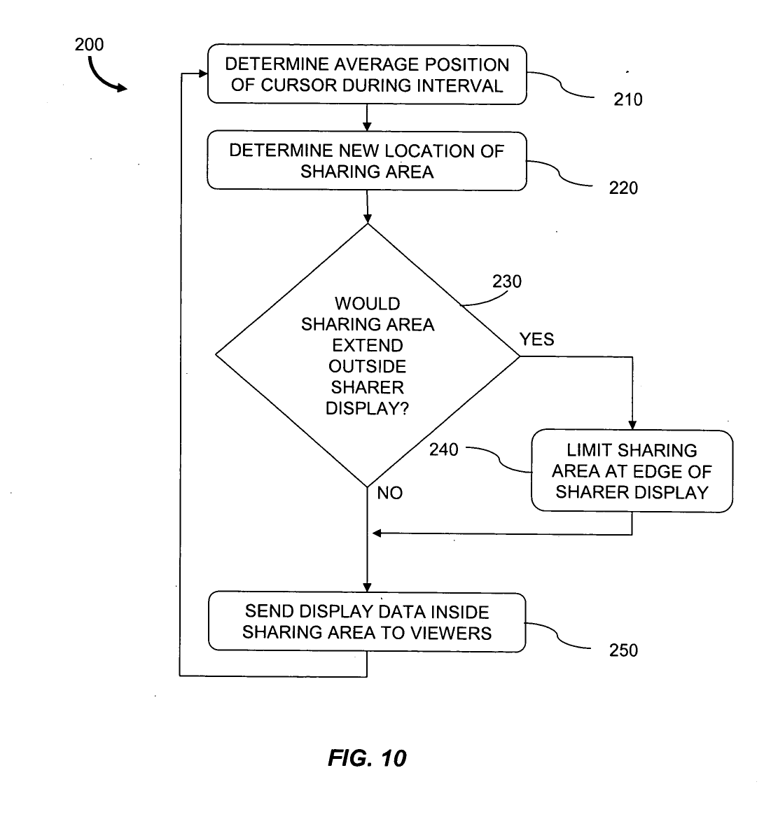

FIG. 10 is a flowchart representation of an embodiment of a method 200 for tracking the sharing area 82 according to the position of the sharer cursor 94. The method includes 200 determining (step 210) a new position of the cursor 94 according to the average position of the cursor 94 during a predetermined interval. The duration of the interval is selected to prevent rapid adjustments in the position of the sharing area 82 in the viewer displays 20 in response to fast movements of the cursor 94 in the sharer display 20. The new location of the sharing area 82 is determined (step 220) from the average position of the cursor 94 during an interval of time subsequent to the last cursor position determination. In one embodiment, the sharing area 82 moves in the sharer display 20 only if the new cursor position is different from the previous cursor position and if the new cursor position is outside the previous sharing area 82. If it is determined (step 230) that the sharing area 82 would extend outside the sharer display 20 based on the new cursor position, adjustment in the position of the sharing area 82 is limited (240) to prevent it from leaving the sharer display 20. The display data corresponding to the current sharing area 82 is then sent (step 250) to the viewing computers 18.

While the invention has been shown and described with reference to specific embodiments, it should be understood by those skilled in the art that various changes in form and detail may be made therein without departing from the spirit and scope of the invention.

1. A method for sharing a portion of a sharer display with a viewer display, the method comprising:
determining a sharing area defining a portion of the sharer display to be shown on the viewer display, the sharing area being responsive to a display allocation for the viewer display and a position of a cursor in the sharer display; and
showing the portion of the sharer display on the viewer display.

2. The method of claim 1 further comprising:
detecting a new position of the cursor in the sharer display;
moving the sharing area to define a different portion of the sharer display in response to the new position of the cursor; and
showing the different portion of the sharer display on the viewer display.

3. The method of claim 2 wherein the detecting comprises detecting an average position of the cursor in the sharer display during a predetermined time interval.

4. The method of claim 2 wherein the moving of the sharing area comprises moving the sharing area to define a different portion of the sharer display if the new position of the cursor in the sharer display is outside the sharing area.

5. The method of claim 1 wherein the determination of a sharing area comprises determining a common area for a plurality of display allocations.

6. The method of claim 1 further comprising showing a sharing frame on the sharer display, the sharing frame indicating the perimeter of the portion of the sharer display showing on the viewer display.

7. The method of claim 6 wherein the sharing frame has a rectangular shape.

8. The method of claim 6 wherein the color of the sharing frame is selected to contrast with a background color of the sharer display.

9. The method of claim 6 wherein the color of the sharing frame is selected to contrast with a feature in the sharer display.

10. The method of claim 6 further comprising:
detecting a new position of the cursor in the sharer display; and
showing the sharing frame at a new position in the sharer display in response to the new position of the cursor.

11. The method of claim 10 wherein the detecting comprises detecting an average position of the cursor in the sharer display during a predetermined time interval.

12. The method of claim 10 wherein the showing the sharing frame at a new position comprises showing the sharing frame at a new position if the new position of the cursor in the sharer display is outside the sharing frame.

13. The method of claim 1 wherein the determination of a sharing area comprises determining a largest common dimension for a plurality of display allocations.

14. The method of claim 1 further comprising polling a viewing computer to determine the display allocation.

15. The method of claim 14 further comprising periodically repeating the polling of the viewing computer to determine an updated sharing area.

16. The method of claim 1 further comprising receiving updated allocation data from a viewing computer, the updated allocation data being transmitted in response to a change in the display allocation.

17. A computer program product for use with a computer system having a sharing computer and a viewing computer, the sharing computer having a sharer display and the viewing computer having a viewing display, the computer program product comprising a computer useable medium having embodied therein program code comprising:
program code for determining a sharing area defining a portion of the sharer display to be shown on the viewer display in response to a display allocation for the viewer display and a position of a cursor in the sharer display; and
program code for showing the portion of the sharer display on the viewer display.

18. The computer program product of claim 17 wherein the program code embodied in the computer useable medium further comprises:
program code for detecting a new position of the cursor in the sharer display;
program code for moving the sharing area to define a different portion of the sharer display in response to the new position of the cursor; and
program code for showing the different portion of the sharer display on the viewer display.

19. The computer program product of claim 17 further comprising program code for showing a sharing frame on the sharer display, the sharing frame indicating the perimeter of the portion of the sharer display showing on the viewer display.

20. The computer program product of claim 19 further comprising:
program code for detecting a new position of the cursor in the sharer display; and
program code for showing the sharing frame at a new position in the sharer display in response to the new position of the cursor.

21. A computer data signal embodied in a carrier wave for use with a computer system having a sharing computer and a viewing computer, the sharing computer having a sharer display and the viewing computer having a viewer display, the computer data signal comprising:
program code for determining a sharing area defining a portion of the sharer display to be shown on the viewer display in response to a display allocation for the viewer display and a position of a cursor in the sharer display; and
program code for showing the portion of the sharer display on the viewer display.

22. The computer data signal of claim 21 wherein the computer data signal further comprises:
program code for detecting a new position of the cursor in the sharer display;
program code for moving the sharing area to define a different portion of the sharer display in response to the new position of the cursor; and
program code for showing the different portion of the sharer display on the viewer display.

23. The computer data signal of claim 21 further comprising program code for showing a sharing frame on the sharer display, the sharing frame indicating the perimeter of the portion of the sharer display showing on the viewer display.

24. The computer data signal of claim 23 further comprising:
program code for detecting a new position of the cursor in the sharer display; and
program code for showing the sharing frame at a new position in the sharer display in response to the new position of the cursor.

25. A computing system for sharing a portion of a sharer display with a viewer display, the computing system comprising:
a sharer processor for determining a sharing area defining a portion of the sharer display to be shown on the viewer display in response to display allocation data for the viewer display and position data for a cursor in the sharer display; and
a shared data generator for providing shared display data to the viewer display.

26. The computing system of claim 25 further comprising a viewer processor in communication with the sharer processor to receive the shared display data and provide viewer display data to the viewer display.

27. The computing system of claim 26 further comprising the viewer display.

28. The computing system of claim 25 wherein the sharer processor detects a new position of the cursor in the sharer display and moves the sharing area to define a different portion of the sharer display in response to the new position of the cursor and wherein the shared data generator provides shared display data responsive to the different portion of the sharer display.

29. The computing system of claim 25 wherein the sharer processor determines a location of a sharing frame to be shown on the sharer display.

30. The computing system of claim 29 wherein the sharer processor determines a new location of the sharing frame in response to a new position of the cursor in the sharer display.
